(19) United States
(12) Patent Application Publication
(10) Pub. No.: US 2018/0316306 A1
(43) Pub. Date: Nov. 1, 2018

(54) SOLAR COLLECTOR OF PHOTOVOLTAIC SYSTEM, IN TUBE FORM, WITH ARRAYS OF CONCENTRATING CELLS, WATER COOLED, IN THE FOCUS OF SEMI CYLINDRICAL, STABLE, PARABOLIC REFLECTOR FOR THE PRODUCTION OF ELECTRICAL AND THERMAL ENERGY

(71) Applicant: Dimos Magklaras, Athens (GR)

(72) Inventor: Dimos Magklaras, Athens (GR)

(21) Appl. No.: 15/520,514

(22) PCT Filed: Oct. 30, 2015
(86) PCT No.: PCT/GR2015/000055

§ 371 Date: Apr. 20, 2017

(30) Foreign Application Priority Data
Oct. 31, 2014 (GR) 20140100549

(51) Int. Cl. H02S 40/22; H02S 40/42

(52) U.S. Cl. CPC H02S 40/22; F24S 23/71; H02S 40/425

(57) ABSTRACT

Vacuum Tube (3) comprising a galvanized iron tube (21) with 2 arrays (26) of attached water cooled photovoltaic concentrating cells (18) in its lower side surface in the focus (19) zones of a parabolic, stable reflector (28). The opening of the parabolic reflector (28) is a reinforced by a Flat Reinforced Mirror (22) in front of it, so that the focuses (19) in suns are reinforced by 40% and so that there is a beneficially techno economical performance of the cells (18). The cells (18) will be put in groups of ten, connected in arrays or in lines, in sandwiches (24) between two layers of isinglass (mica) (23), so that there is a thermally conductible contact with the galvanized iron tube, but not electrically conductible. The support of each sandwich (24) of a group of ten cells is achieved by natural magnets (25) in the rims (27). The terminals of each group of cells (18) are connected with the next group through a by pass access (diode), in case there is a faulty cell (18) and thus faulty group. The vacuum tube generates electrical energy and hot water circulating inside the galvanized iron tube produces thermal energy. Thermal energy is for household, industrial uses, air conditioning and desalinations.

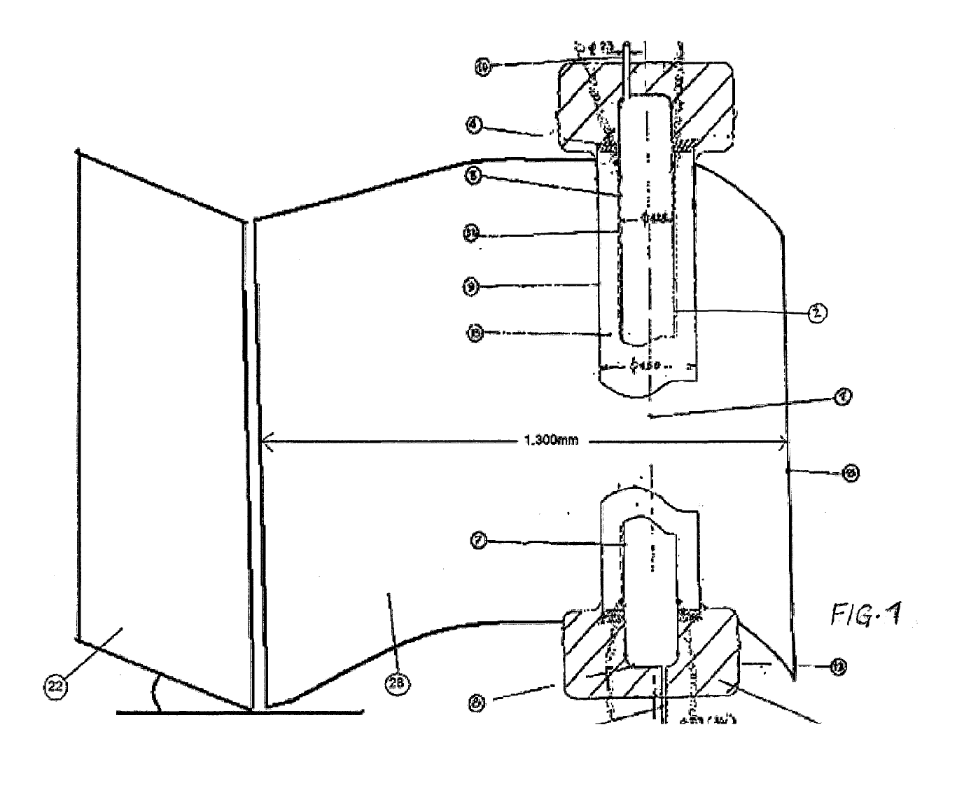

The up to now solutions, with the use of concentration cells, led to unprofitable economically solution of products. That is why with my present invention, we create a solar collector (1), which consists of a semi cylindrical reflector, properly parabolic (28) (FIGS. 1&2), and not semi (faulty) parabolic, which leads to the need of using many arrays (20) of concentrating cells (18) and increases the total cost of the collector (1) and thus, becomes uneconomical. With the “property parabolic” (28), on the other hand, we need only two arrays (20) of concentrating cells, from noon and for about six hours on, and just on the bottom part (side) of the reflector (28).

The collector (1) is placed horizontally with the reflector always facing South and with an inclination (28) depending on the latitude of the area and maybe the time of year. Due to the fact that the concentrating cells (18) perform satisfactorily in high sunlight concentration (19), the techno economic result will lead to an economically useful product. Thus the invention dictates to put in front of the lower part of the semi cylindrical parabolic reflector (28), even between the parabolic (28) in a central installation photovoltaic collectors (1), of tube form), a Flat Reinforced Mirror (22) in a proper way, so that the focal points (19) at the lower sides of the parabolic reflector (28), in the focus (19) of the iron tube, will increase by almost 40% in sun concentration! This is a fundamental addition, with no major extra cost of the system. This addition alone makes the invention useful, so as that it can lead us to a beneficial techno economic product, due to greater performance per cell (18) and that it can be promoted into the International Market!

Next as a third characteristic, we can enlarge the opening of just the lower side of the reflector (28), which we can reinforce in suns the concentration of its focus (19) by 1 m×1.97 m [1 m width from the middle (axis) of the vacuum tube (3) and 1.97 m the length of the reflector (28)].

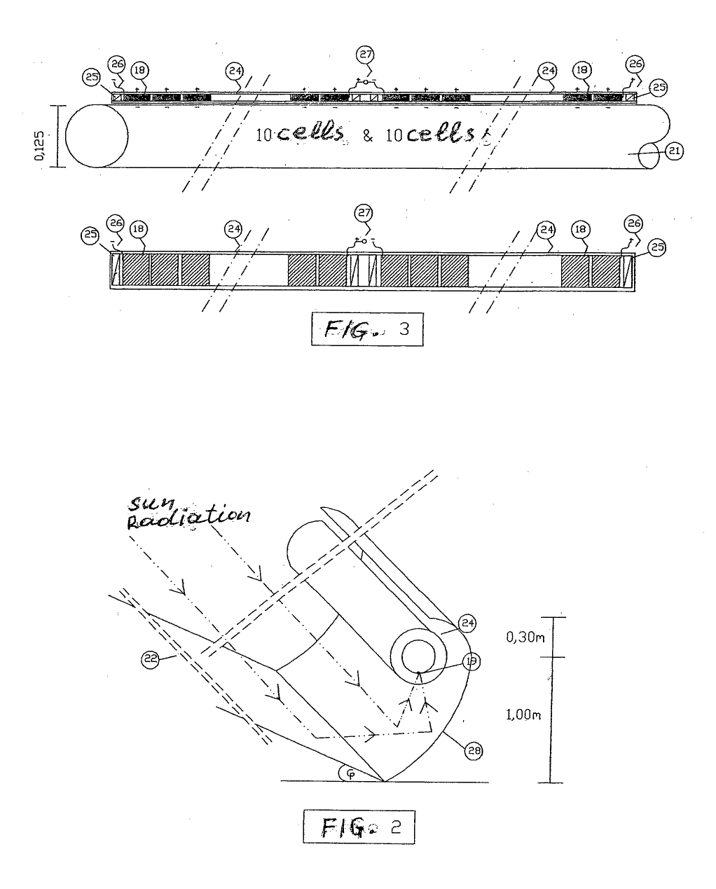

The dimensions are indicative and by no means binding, as far as our invention is concerned. At the same time, as we do not have the ability to reinforce sunlight on the upper side of the reflector (28), we limit the width of the opening from the axis of the vacuum tube (3) by 30 or 20 cm×1.97 m, since the installation of concentrating cells (18) without the sunlight reinforcement will be unprofitable due to the poor performance of the cells (18) and thus, since I will not install arrays (20) on the top focal points due to little sunlight, I limit the opening of the reflector (28) so as not to create a bulgy collector, (1) (FIGS. 1&2) by doubling its height or increase the cost, for no particular reason, and simultaneously doubling the space needed for installation. (Not densely, to avoid the reflectors shadowing one another.) Thus, we gain in the lower linear focus (19), by enlarging the opening by 1 m (not binding for the invention), 50 to 65 suns per 1 sq. cm of the linear focus (19), which will have concentrating cells respectively (18) and with the Flat Reinforcing Mirror (22) [×1.35=70 to 85 suns at least], so as to have satisfactory performances of the cells (18). 78 suns/1 cm2. (cell) gives 7.8 W/1 cm2 (cell)×0.35 efficiency=2.73 Watt/cm (cell) and COLLECTOR'S POWER=[200 cells (in two arrays)×2.73 W/cell]=546 Watt/COLLECTOR. Simultaneously, 11.000 Kcal/day. Coll. aver. summer Thermal performance, (from 20° C. to 80° C. use hot water.) Due to the Flat Reinforcing Mirror (22) there is a simultaneous increase in the thermal energy, and that is why we decrease the overheating of the fluid or water (7) for the water cooling system and the best performance of the concentrating cells (18), the vacuum tube (3) will be only of two layers (FIG. 1) [iron tube (21), galvanized inside glass tube (9)] and of open circuit, with black surface of graphite color, not black titanium. (By using graphite, the thermal loss of radiation, will be 65%, so as the cells (18) do not become overheated) In addition, we conclude this invention regarding the way the photovoltaic concentrating cells (18) are installed and supported inside the glass tube (9) Since there is a problem to be supported in linear focal points (19) (FIG. 2) but in a way thermally conducted towards the iron tube (21) (FIGS. 2&3) of the vacuum tube (3) and electrically not conductible! And b) in a way that small moves can be performed in the linear focus (20) inside the glass tube (9) with the sealed vacuum (13) for the best focus (19) of the cells (18) depending on the latitude that the collector will be installed (1) (up or down). So, with the four (4) points of this invention, we clarify and we guarantee that in order for the cells not to be overheated (18) we have to, as we have already mentioned, the support of the linear focus (24) to be by using isinglass (mica) (23), so as the conduct with the iron tube (21) to be thermally conductible, but electrically non conductible. Our invention can handle any other material that has the same characteristics as isinglass (21) e.g. special material paint. This is another basic point of my invention. We continue by saying that for a better adjustment in the units (19) while the arrays (26) of cells (18) are already adjusted inside the sealed (4) vacuum (3) of the glass tube (9) (FIG. 1), we join (+−) (+−) in the cells (18) by 5 and up to 10 almost in a line (26). Each team is tied like a ‘sandwich’ (24) between two pieces of isinglass (mica) (23) [up and down items of isinglass (23)] and this sandwich (24) enters the mental array (26) that is calculated to exist for 5-6 hours daily around noon. The support will be performed through small magnets (25), which we stick to both ends of each sandwich (24) of the isinglass (23) which attaches mechanically now the iron tube (21), due to the pull of the magnets (25), or by special glue-silicone etc, which exist inside the glass tube (9) with the vacuum or the sealed air (13) or noble gas, which will usually be galvanized (21). If both sandwiches (24) in a row are [of 10 cells (18) each] its poles are joined (+−) or (++) (− −) so as to have an array (26) 2 sandwiches (24) indicatively and not binding, 20 to 40 cells (18), so that e.g. 20 cells×2.6 V=52 Volt and that is why we should not exceed the 60 Volt inside a vacuum tube (3). Thus, we arrange the poles (17) of every 20 cells (not binding) to be out of the glass tube (9) in a line or/and in parallel. The teams of cells that are joined (+ −) may be joined in a parallel way, so as not to be here a reason for an invention. There should also be steadiness between the lines—terminals (27) of each team of ten even when the contacts are completed (27), so that we can move them a little up or down if needed to improve the focus (of the focal point) (19) with the help of a magnet (our tool) outside of the glass tube (9)! This way of support consists of the 5th basic point of this new invention of mine, as it is the only way one can utilize these collective cells (18) in such a cylindrical form of photovoltaic in the unit of a parabolic reflector (28). Without being bound by the micro shifting, the support can be achieved without the natural magnets (25) and the sandwiches (24) can be joined together with isinglass (23) in groups of ten or of twenty. As 6th improvement of this invention, per group of ten or twenty units we add in a linear way, an exit (diode), so as to secure them as a bypass, that is, cancel the dysfunctional group of ten in case of a 30 faulty cell (hence the group of ten), but not to cancel the function and the performance of the whole array (26).

1. Solar collector of photovoltaic system of tube form (1) (FIG. 1) with 2 arrays (26) (not binding) of concentrating cells (18) water cooled, in the focus of semi cylindrical parabolic reflector (28) (FIGS. 1 &2) and not paraboloid (faulty parabolic) In this invention, according to which, a vacuum tube (3) is consisted of galvanized iron tube (21), of a glass tube (9) sealed in the rims (4) so that it can maintain the vacuum, space technology vacuum [10″4BAR, not binding]. The semi cylindrical reflector is properly parabolic (28) (FIGS. 1& 2) and not semi(faulty) parabolic (paraboloid), which creates a lot of movement to the linear focus (19), and thus is uneconomical. It can also be uneconomical if the reflector (28) is moved so that the focus is in the same point as the focus (19). Inside the iron tube (21) of course, there will be water or fluid (7) for the freezing of the cells (18), and to achieve their best performance, up to 100° C., and thus we gain production of thermal energy as well as electric. The collector (1) is placed horizontally and the lower opening of the reflector is big, about 1 meter, not binding, from the axis of the tube (3) and so it accumulates a satisfactory number of suns, in linear focus (19) of the lower side, which is reinforced even more by a Flat Reinforcing Mirror (22) installed at an angle. A second reflection increases the suns in the linear focus (19) [up to 40%!]. Thus the cells (18) perform satisfactorily. The upper opening of the reflector (28) that cannot be reinforced, is made with an opening of about 20 cm, not binding, so that the collector (1) is not very bulgy, without a reason ! The concentrating cells (18) will be supported at the focuses of the iron tube (21) and inside the glass tube (9), with the vacuum separated into sandwiches (24) between isinglass (mica) (23) in groups of ten (not binding), so that the connection with the iron tube (21) will be electrically not conductible, but thermally conductible and so that the heat circulates inside the water or fluid (13) that exists in the iron tube (21) and the cells (18) function properly between 15° and 85° C., average grade 50° C. Thus the cells satisfactorily produce electric and thermal energy at the same time! As far as the sandwiches (24) are concerned, are of ten cells (18), that can be strips of ten cells (if they are connected in a parallel way) and are supported between isinglass (mica) (23) with the help of natural micro magnets (25) connected to the rims of the sandwich (24). Also, every group of ten is connected with the other through by pass (27), so that the flawed cell (18) and, by extension the group of ten, will not cancel the function of the whole array (26), e.g. from 100 cells (18) !

2. Solar collector of photovoltaic system of tube form (1) with 2 arrays (26) of concentrating cells (18), water cooled, in the focus of semi cylindrical parabolic reflector (28) according to the 1st claim of this invention, that is based on the fact that the lower opening of the parabolic reflector (28) is relatively big, about 1 m×1.97 m (the length) not binding regarding the dimensions, and the upper opening smaller, so that the height of the collector does not increase and create space problems and either way, it would not be beneficial in electric performances! Before the lower opening of the parabolic reflector (28) we place, in a proper way, a Flat Reinforcing Mirror (22) that increases the suns in the linear focuses (19) of the lower side of the tube (3) by almost 40%, so that the performance of the cells (18) of this array (26) will be more beneficial and the product ends up to be more techno economically acceptable by this invention (FIGS. 1&2).

3. Solar collector of photovoltaic system of tube form (1) with 2 arrays (26) of concentrating cells (18), water cooled, in the focus of semi cylindrical parabolic reflector (28) according to the 1 st claim of this invention, that is based on the fact that the thermal conduct and the electrically not conductible support of the cells is achieved with the creation of ten linearly connected cells (18) (not binding regarding the number of cells) (+ −) (+ −) and in the form of sandwiches (24) between strips of isinglass (mica) (23) will be attached in the side surface of the cylindrical iron tube (21), in the spots of linear focus (19) and with the assistance of small, natural magnets (25) that are skillfully attached at both ends of each sandwich (24) and due to the stamina of the tubes at the rims (27) of each sandwich (24) subtle movement up down) should be possible for the cells, even though they are sealed inside a glass tube (9) of vacuum or noble gas or air (13) (so as to decrease cell (18) over heating).

4. Solar collector of photovoltaic system of tube form (1) with 2 arrays (26) of concentrating cells (18), water cooled, in the focus of semi cylindrical parabolic reflector (28) according to the 1 st claim claims of this invention, that are based on the fact that the group of ten by two or three in line (if they are fewer than ten), in an array of about 22 cells (18), with (+) and (−) terminals (27), which exit the glass tube (9), so that each team will not exceed 60V. Because of the terminal (+·) of each group of ten or twenty enters in line with a small element (diode) access by pass (27) so that we will be able, if need be, to put it out of array (26) and protect the cancellation or the non production of the whole array (26).

5. Solar collector of photovoltaic system of tube form (1) with 2 arrays (26) of concentrating cells (18), water cooled, in the focus of semi cylindrical parabolic reflector (28) according to the 1st claim, in arrays (26) in all the length of the focus (19) inside the glass tube (9) of length of about 2 m (not binding) in length of about 1.80 m (6 groups of twenty) not binding for my invention.
